(19) United States
(12) Patent Application Publication
(10) Pub. No.: US 2023/0132728 A1
(43) Pub. Date: May 4, 2023

(54) CHITOSAN CONTAINING PET CHEW

(71) Applicant: T.F.H. PUBLICATIONS, INC., Neptune City, NJ (US)

(72) Inventors: Glen S. AXELROD, Colts Neck, NJ (US); Ajay GAJRIA, Monmouth Junction, NJ (US)

(21) Appl. No.: 18/051,087

(22) Filed: Oct. 31, 2022

Related U.S. Application Data
(60) Provisional application No. 63/263,366, filed on Nov. 1, 2021.

(51) Int. Cl. A23K 20/163; A23K 40/30; A23K 20/179; A23K 50/42

(52) U.S. Cl. CPC A23K 20/163; A23K 40/30; A23K 20/179; A23K 50/42

(57) ABSTRACT

A chitosan containing pet chew. Such chitosan containing pet treat can be formed by an aqueous based pressuring cooking procedure and/or by immersing a pet chew in an aqueous based solution containing chitosan, wherein the chitosan is then selectively present at the pet chew surface.

### FIELD

The present invention stands directed at a chitosan containing pet chew. Such chitosan containing pet treat can be formed by an aqueous based pressuring cooking procedure and/or by immersing a pet chew in an aqueous based solution containing chitosan, wherein the chitosan is then selectively present at the pet chew surface.

### BACKGROUND

Chitosan is reported in the literature as providing antimicrobial activity as a bacteriocide and fungicide. Chitosan is often identified as poly-[1-4-β-D-glucosamine]. Chitosan may be chemically derived from chitin which is poly-N-acetyl-D-glucosamine.

### SUMMARY

A polymer-based pet chew having a surface and comprising a polymeric resin and chitosan, wherein said chitosan is present from said surface to a thickness of 0.1 mm to 10.0 mm into said pet chew.

A method for forming a pet chew by providing a polymer-based pet chew having a surface along with a mixture of chitosan and water wherein the chitosan is present in the water at a level of 0.1% by weigh to 10.0% by weight. This is then followed by exposing the polymer-based pet chew to the chitosan and water mixture and impregnating the surface of said pet chew with said chitosan. This may be achieved by dipping or soaking the polymer-based pet chew in chitosan/water mixture. Optionally, one may heat the chitosan/water mixture or heat the chitosan/water mixture within a pressure vessel.

### DETAILED DESCRIPTION

The present invention stands directed at a chitosan containing pet chew. Chitosan herein is reference to the polysaccharide composed mainly (at least 50% or more) of randomly distributed β-(1→4)-linked D-glucosamine (deacetylated unit) and N-acetyl-D-glucosamine (acetylated unit). It is typically made by treating the chitin shells of shrimp and other crustaceans with an alkaline substance, such as sodium hydroxide. When fully deacetylated, the structure of chitosan appears as follows:

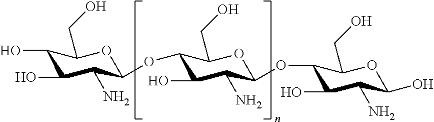

The chitosan containing pet chew herein is preferably formed by an aqueous based pressuring cooking procedure and/or by immersing a pet chew in an aqueous solution containing chitosan. Preferably, the pet chew herein is composed of one or more polymers, such as polyamides (nylons), polyesters, polyurethanes, thermoplastic polyester-based elastomers, thermoplastic polyurethane elastomers, diene rubbers (e.g. polyisoprene or polybutadiene), styrene-butadiene rubbers. It is also contemplated that one may utilize thermoset polyurethane type resins, and in particular, thermoset polyurethane elastomers.

The pet chew herein may preferably be formed by injection molding, compression molding, or extrusion. The aforementioned polymeric resins may therefore be formed into a desired shape, such as a simulated bone structure or some other configuration suitable for a pet chew shape.

As alluded to above, chitosan is preferably mixed with water, where the chitosan is preferably present at a level of 0.1% to 10.0% by weight. Preferably, the aqueous solution is made slightly acidic, meaning it is configured to have a pH of 6.5 or lower, more preferably in the pH range of 3.0 to 6.5, or even more preferably in the pH range of 3.0 to 4.0. Preferably, the acidity may be provided by including in the water an appropriate amount of one or more of the following acids: acetic acid, formic acid, lactic acid, propionic acid and/or succinic acid. One particularly preferred mixture of chitosan and water is a water solution containing 0.5% to 8.0% acetic acid, or even more preferably, 0.5% to 5.0% acetic acid. Optionally, the aqueous mixture of water and chitosan may contain a colorant, where the colorant is itself preferably present at a level of 0.1% by weight to 5.0% by weight. In addition, the aqueous mixture of water and chitosan may contain a flavoring, also preferably present at a level of 0.1% by weight to 5.0% by weight.

The above referenced mixture of chitosan and water, optionally with coloring and/or flavoring, serves as the source for impregnation of the surface of the polymer-based pet chew with a desired level of chitosan, coloring and/or flavoring. As alluded to above, the polymer-based pet chew may be placed in the chitosan/water mixture for a period of time, e.g. up to 6.0 hours. The chitosan water mixture may also optionally be heated to a temperature in the range of 100° F. to 200° F. It is also contemplated herein that once removed from the chitosan/water mixture, the polymer-based pet chew now containing the chitosan may undergo drying, and preferably via fluidized bed drying.

In one preferred procedure, the polymer-based pet chew may be placed in a pressure vessel containing the chitosan/water mixture, optionally with coloring and/or flavoring, and heated such that steam pressure is generated, along with pressure. Accordingly, the boiling point of the water is raised such that the boiling point can get as high as 250° F. This then is contemplated to improve the absorption of the chitosan and optional colorant and flavoring into the surface of the polymeric-based pet chew. Preferably, the polymer-based pet chew is heated and pressurized in the pressure cooker for a period of 30 minutes to 6.0 hours, or 30 minutes to 3.0 hours, or 30 minutes to 1.0 hour.

Another preferred procedure for impregnating the surface of the polymer-based pet chew with chitosan and optionally colorant and flavoring, is to immerse the pet chew in the above referenced water mixture. The polymer-based pet chew may then be allowed to remain in such water mixture, at room temperature, for periods of up to 120 hours, or preferably in the range of 1.0 hours to 120 hours.

Preferably, the chitosan, optionally with the colorant and/or flavoring, is present on and impregnated into the polymer-based pet chew surface. Such impregnation is contemplated to be from the surface and into the polymer-based pet chew to a thickness of 0.1 mm to 10.0 mm, more preferably, at a thickness level of 1.0 mm to 5.0 mm. Accordingly, the polymer-based pet chew now has a surface where chitosan and the optional colorant and/or flavoring is present at the surface and to a depth or thickness of 0.1 mm to 10.0 mm.

It is noted that one of the properties of chitosan is its ability to provide antimicrobial activity to gram-negative and gram-positive bacteria, as well as activity toward fungi. As may be appreciated, when dogs engage with a pet chew, the surface of the chew may then otherwise serve as a medium for bacterial or fungi growth. It is therefore contemplated herein that by selectively providing chitosan at the surface of a polymer-based pet chew, the ability for bacterial or fungi growth can now be attenuated or eliminated.

In addition, by selectively imbedding chitosan from the surface of the pet chew and to a selected depth, along with coloring, the consumer will now be provided with a visual indicator as to when the chitosan impregnated surface itself has been compromised or removed. In other words, after sustained periods of chewing, the chitosan and color impregnated surface would be worn away by the animal, and the consumer would then be able to recognize that the anti-bacterial and/or anti-fungal surface features are no longer present. In such regard, the colorant and or flavoring may similarly be present at the surface of the pet chew and into the thickness of the pet chew at a level of 0.1 mm to 10.0 mm, more preferably at a thickness level of 0.1 mm to 5.0 mm.

The present invention therefore provides a polymer-based pet chew with a surface containing chitosan, down to a selected depth, optionally along with colorant and/or flavoring. The chitosan at the surface and down to a selected depth provides both antibacterial and antifungal properties to reduce and/or eliminate propagation of bacteria and fungus that may otherwise develop from the chewing action by the animal. The consumer is also provided with a visual indication as to when such antibacterial and antifungal characteristics of the pet chew are compromised and no longer present.

More generally, the present invention also stands directed at a method for forming a pet chew comprising supplying a polymer-based pet chew having a surface; supplying a mixture of chitosan and water wherein the chitosan is present in said water at a level of 0.1% by weigh to 10.0% by weight; exposing said polymer-based pet chew to said chitosan and water mixture and impregnating said surface of said pet chew with said chitosan.

The present invention also more generally relates to a polymer-based pet chew having a surface and comprising a polymeric resin and chitosan, wherein the chitosan is present from the surface to a thickness of 0.1 mm to 10.0 mm into the pet chew

1. A method for forming a pet chew comprising:
supplying a polymer-based pet chew having a surface;
supplying a mixture of chitosan and water wherein the chitosan is present in said water at a level of 0.1% by weigh to 10.0% by weight;
exposing said polymer-based pet chew to said chitosan and water mixture and impregnating said surface of said pet chew with said chitosan.

2. The method of claim 1 wherein said exposing of said polymer-based pet chew to said chitosan and water mixture comprises placing said chitosan and water mixture into a pressure vessel with said polymer-based pet chew and heating and/or pressurizing.

3. The method of claim 1 wherein said exposing of said polymer-based pet chew to said chitosan and water mixture comprises immersing said polymer-based pet chew in said chitosan and water mixture for a period of time of up to 120 hours.

4. The method of claim 1 wherein said mixture of chitosan and water has a pH of 6.5 or lower.

5. The method of claim 1 wherein said mixture of chitosan and water has a pH in the range of 3.0 to 6.5.

6. The method of claim 4 wherein said mixture of chitosan and water contains one or more of acetic acid, formic acid, lactic acid, propionic acid or succinic acid.

7. The method of claim 1 wherein said chitosan and water mixture further comprises a colorant at a level of 0.1% by weight to 5.0% by weight.

8. The method of claim 1 wherein said chitosan and water mixture further comprises a flavoring at a level of 0.1% by weight to 5.0% by weight.

9. The method of claim 1 wherein said chitosan impregnates said surface of said polymer-based pet chew from the surface to a thickness of 0.1 mm to 10.0 mm.

10. The method of claim 7 wherein said colorant impregnates the surface of said polymer-based pet chew from the surface to a thickness of 0.1 mm to 10.0 mm into said pet chew.

11. The method of claim 8 wherein said flavoring impregnated the surface of said polymer-based pet chew from the surface to a thickness of 0.1 mm to 10.0 mm.

12. A polymer-based pet chew having a surface and comprising a polymeric resin and chitosan, wherein said chitosan is present from said surface to a thickness of 0.1 mm to 10.0 mm into said pet chew.

13. The polymer-based pet chew of claim 12 wherein said polymeric resin is selected from the group consisting of polyamides, polyesters, polyurethanes, thermoplastic polyester elastomers, thermoplastic polyurethane elastomers, diene rubbers, styrene-butadiene rubbers, or thermoset polyurethanes.

14. The polymer-based pet chew of claim 12 further containing a colorant or flavoring.

15. The polymer-based pet chew of claim 12 wherein said chitosan is present from said surface to a thickness of 0.1 mm to 5.0 mm into said pet chew.
